(19) United States
(12) Patent Application Publication
(10) Pub. No.: US 2024/0238161 A1
(43) Pub. Date: Jul. 18, 2024

(54) COUPLER AND DRUG PREPARATION DEVICE

(71) Applicant: NIPRO CORPORATION, Osaka-shi, Osaka (JP)

(72) Inventor: Tomohiko KUBO, Osaka-shi, Osaka (JP)

(21) Appl. No.: 18/549,768

(22) PCT Filed: Mar. 10, 2022
(86) PCT No.: PCT/JP2022/010439

§ 371 Date: Sep. 8, 2023

(30) Foreign Application Priority Data
Mar. 12, 2021 (JP) 2021-040741

(51) Int. Cl. A61J 1/20

(52) U.S. Cl. CPC A61J 1/20

(57) ABSTRACT

A coupler comprises a syringe attachment part to which a syringe including a nozzle part having a lock collar is detachably attached; a vial attachment part to which a vial is attached; and a double-ended needle for placing the syringe and the vial in communication. In the coupler, a cap which covers the nozzle part of the syringe is attached to a cap holder having an engaging part for engagement with the lock collar; a holding mechanism is provided which holds an engaged state of the engaging part with the lock collar; and a release mechanism is provided which releases holding of the engaged state of the engaging part with the lock collar in the holding mechanism due to the syringe and the vial being moved relatively closer to each other to be placed in communication by the double-ended needle.

### TECHNICAL FIELD

This invention relates to a coupler for connecting a vial and a syringe, and to a drug preparation device using such coupler.

### BACKGROUND ART

Conventionally, couplers for connecting a vial and a syringe have been known for mixing and preparing a powder preparation, etc. in a vial and a solution, etc. in a syringe. For example, in Japanese Patent No. JP-B-5333850 (Patent Document 1), the applicant disclosed a coupler for coupling a syringe and a vial. According to such coupler, a powder preparation in a vial can be dissolved in a solution in a syringe by connecting the internal space of the syringe and the internal space of the vial, and then the drug can be administered to a patient as a liquid drug using a syringe removed from the coupler.

### BACKGROUND ART DOCUMENT

### Patent Document

Patent Document 1: JP-B-5333850

### SUMMARY OF THE INVENTION

### Problem the Invention Attempts to Solve

Meanwhile, the coupler disclosed in Patent Document 1 employs a syringe holding member equipped with a female thread that is threaded onto a male thread formed on the outer circumferential surface of the syringe's mouth part. By engaging and disengaging these male and female threads with respect to each other, the syringe can be connected to or detached from the coupler.

However, in the coupler described in Patent Document 1 as an example, it is necessary to provide a groove extending in the axial direction to the male and female threads for preventing inadvertent detachment of the syringe from the coupler, and to form a detachment prevention means that enters the groove while preventing and allowing relative rotation of the male and female threads integrally with a double-ended needle with a partial thread structure that can be threaded onto the male threads. This may cause the shape of the syringe and the coupler (the syringe holding member) to become relatively complicated, which limits the shape and material of each member of the syringe and the coupler, which may make manufacturing difficult. In addition, the need for a specific operation involving rotation when detaching the syringe may make it difficult to perform the operation quickly.

It is therefore one object of the present invention to provide a novel coupler and a novel drug preparation device with at least one improvement that is able to improve the practical utility of the coupler described in Patent Document 1.

### Means for Solving the Problem

Hereinafter, preferred embodiments for grasping the present invention will be described. However, each preferred embodiment described below is exemplary and can be appropriately combined with each other. Besides, a plurality of elements described in each preferred embodiment can be recognized and adopted as independently as possible, or can also be appropriately combined with any element described in other preferred embodiments. By so doing, in the present invention, various other preferred embodiments can be realized without being limited to those described below.

A first preferred embodiment provides a coupler comprising: a syringe attachment part configured to detachably receive a syringe including a nozzle part, the nozzle part having a lock collar; a vial attachment part configured to receive a vial; a double-ended needle configured to place the syringe and the vial in communication; a cap holder including an engaging part configured to engage with the lock collar; a cap configured to cover the nozzle part of the syringe, the cap being attached to the cap holder; a holding mechanism configured to hold the engaging part in an engaged state with the lock collar; and a release mechanism configured to release holding of the engaged state between the engaging part and the lock collar in the holding mechanism due to the syringe and the vial being moved relatively closer to each other to be placed in communication by the double-ended needle.

In the coupler of the present preferred embodiment, the holding mechanism holds the engaging part of the cap holder in an engaged state with the lock collar. With this configuration, the syringe including the lock collar is held in a coupled state to the coupler, and the syringe is prevented from accidentally falling out of the coupler. Besides, due to the syringe and the vial being placed in communication, the release mechanism releases the holding of the engaged state between the engaging part and the lock collar in the cap holder. This prevents the syringe from being detached from the coupler before the vial is connected.

In this way, the coupler of the present preferred embodiment newly adopt a cap holder attached to the cap and engaged with the lock collar, and is provided with the holding mechanism and the release mechanism to respectively realize engagement and disengagement of the said cap holder with respect to the lock collar in correspondence with the communication operation by the double-ended needle. This makes it possible to couple and detach the syringe with respect to the coupler without using a special thread structure such as a grooved thread or a partial thread as described in the example of Patent Document 1. Therefore, compared to the coupler described in the example of Patent Document 1, for example, the structure of the coupler can be simplified to facilitate manufacturing, and the degree of freedom in designing each component including the lock collar of the syringe and the degree of freedom in selecting the materials thereof and the like can be improved.

A second preferred embodiment provides the coupler according to the first preferred embodiment, further comprising a cap retaining mechanism configured to hold the cap attached to the nozzle part of the syringe in the syringe attachment part, the cap retaining mechanism being configured to retain the cap separated from the nozzle part when the syringe is detached from the syringe attachment part.

In the coupler of the present preferred embodiment, the cap stays inside the coupler when the syringe is detached, thereby eliminating the need to remove the cap from the syringe after the syringe is detached. In addition, since the user will not touch the cap after the syringe is detached, accidental touch with the drug or the like contained in the syringe can be avoided. The cap may be retained in the syringe attachment part of the coupler directly by the cap retaining mechanism, or the cap may be retained in the syringe attachment part by the cap holder that is attached to the cap being retained by the cap retaining mechanism.

A third preferred embodiment provides the coupler according to the first or second preferred embodiment, wherein the engaging part of the cap holder is configured to come into convexo-concave engagement with an outer circumferential surface of the lock collar, and the holding mechanism comprises a deformation limiting part that is arranged on a radially outer side of the engaging part and is configured to limit radially outward deformation of the engaging part thereby holding the engaging part in the engaged state with the outer circumferential surface of the lock collar.

In the coupler of the present preferred embodiment, the engagement between the engaging part of the cap holder and the lock collar is realized by convexo-concave engagement, and the said convexo-concave engagement is held by the deformation limiting part in the holding mechanism. This makes it possible to realize the holding mechanism with a relatively simple structure, and to improve the degree of freedom of shape and material more reliably.

A fourth preferred embodiment provides the coupler according to the third preferred embodiment, wherein the deformation limiting part is integrally provided with the double-ended needle, and due to the double-ended needle being moved in a direction of getting closer to the syringe to puncture the cap, the deformation limiting part is configured to move to a position away from the engaging part of the cap holder attached to the syringe such that detachment of the engaging part from the lock collar is allowed by the radially outward deformation of the engaging part to constitute the release mechanism.

In the coupler of the present preferred embodiment, the convexo-concave engagement can be released by the deformation limiting part moving away from the engagement position between the engaging part of the cap holder and the lock collar. Thus, the release mechanism can be realized with a relatively simple structure. Besides, since the deformation limiting part is integrally provided with the double-ended needle, the increase in the number of components can be suppressed, thereby manufacturing the coupler with a simpler structure.

A fifth preferred embodiment provides the coupler according to the fourth preferred embodiment, wherein the double-ended needle is configured to be subjected to pushing force by insertion of the vial, and the pushing force causes the double-ended needle to move in the direction of getting closer to the syringe to puncture the cap.

In the coupler of the present preferred embodiment, the double-ended needle and the deformation limiting part move toward the syringe due to insertion of the vial, and the convexo-concave engagement between the engaging part of the cap holder and the lock collar is released, thereby enabling the syringe to be detached from the coupler. Specifically, due to insertion of the vial, the release mechanism releases the convexo-concave engagement between the engaging part of the cap holder and the lock collar. Thus, there is no need to perform complicated operations in releasing the convexo-concave engagement, thereby readily performing the release operation by means of the release mechanism.

A sixth preferred embodiment provides the coupler according to any of the first through fifth preferred embodiments, further comprising a housing member having a tubular shape and configured to receive the syringe and the vial respectively on a first axial opening side and a second axial opening side, wherein the double-ended needle is attached to the housing member movably in an axial direction, a first locking mechanism is provided on the first axial opening side of the housing member, the first locking mechanism permitting insertion of the cap and the cap holder while preventing detachment of the cap and the cap holder, and a second locking mechanism is provided on the second axial opening side of the housing member, the second locking mechanism permitting insertion of the vial while preventing detachment of the vial.

In the coupler of the present preferred embodiment, the first locking mechanism and the second locking mechanism are provided in the housing member. Thus, the housing member can hold the syringe, to which the cap and the cap holder are attached, and the vial in an assembled state.

The seventh preferred embodiment provides a drug preparation device comprising: the coupler according to any of the first through sixth preferred embodiments; and the syringe combined with the coupler, the syringe being detachable with respect to the syringe attachment part and comprising: a syringe main body; and the lock collar that is a separate component from the syringe main body and is fixedly attached to the nozzle part of the syringe main body.

In the drug preparation device of the present preferred embodiment, the syringe main body and the lock collar are separate components, so that improvement in the degree of freedom in designing the syringe main body and the lock collar or the like can be achieved, for example. Therefore, for example, glass can be adopted as the material of the syringe main body while a lock collar made of synthetic resin can also be adopted, and a glass syringe of relatively simple shape, which has been commercially available from the past, can also be applied.

### Effect of the Invention

According to the present invention, it is possible to provide a coupler and a drug preparation device with at least one improvement over the coupler described in Patent Document 1, such as, for example, simplification of the structure, which may improve the practical utility of the coupler.

### BRIEF DESCRIPTION OF THE DRAWINGS

FIG. 1 is a perspective view showing a drug preparation device as a first practical embodiment of the present invention.

FIG. 2 is a front view of the drug preparation device shown in FIG. 1.

FIG. 3 is a cross sectional view taken along line 3-3 of FIG. 2.

FIG. 4 is a cross sectional view taken along line 4-4 of FIG. 3.

FIG. 5 is a vertical cross-sectional perspective view of a transfusion needle unit constituting the drug preparation device shown in FIG. 1.

FIG. 6 is an exploded perspective view of the transfusion needle unit shown in FIG. 5.

FIG. 7 is an exploded perspective view of the transfusion needle unit shown in FIG. 5 from another direction.

FIG. 8 is an exploded perspective view of a cap unit constituting the drug preparation device shown in FIG. 1.

FIG. 9 is a perspective view of a nest syringe constituting the drug preparation device shown in FIG. 1.

FIG. 10 is an enlarged vertical cross sectional view of a cap holder constituting the cap unit shown in FIG. 8.

FIG. 11 is a vertical cross sectional view of the drug preparation device shown in FIG. 1 with a vial attached, corresponding to FIG. 3.

FIG. 12 is a cross sectional view taken along line 12-12 of FIG. 11.

FIG. 13 is a vertical cross sectional view of the drug preparation device shown in FIG. 11 with a syringe and the vial placed in communication, corresponding to FIG. 3.

FIG. 14 is a cross sectional view taken along line 14-14 of FIG. 13.

FIG. 15 is a vertical cross sectional view of the drug preparation device shown in FIG. 13 with the syringe including a lock collar detached, corresponding to FIG. 3.

FIG. 16 is a cross sectional view taken along line 16-16 of FIG. 15.

### EMBODIMENTS FOR CARRYING OUT THE INVENTION

Hereinafter, a practical embodiment of the present invention will be described in reference to the drawings.

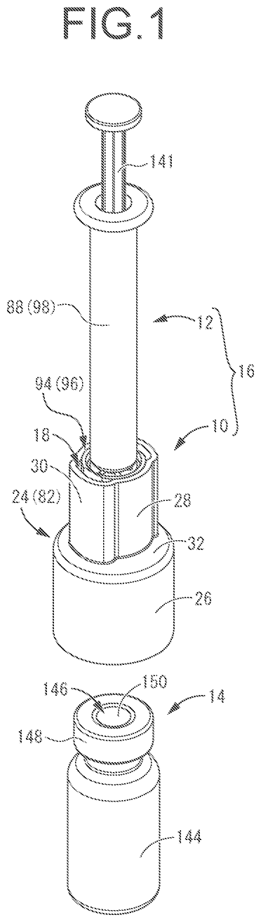

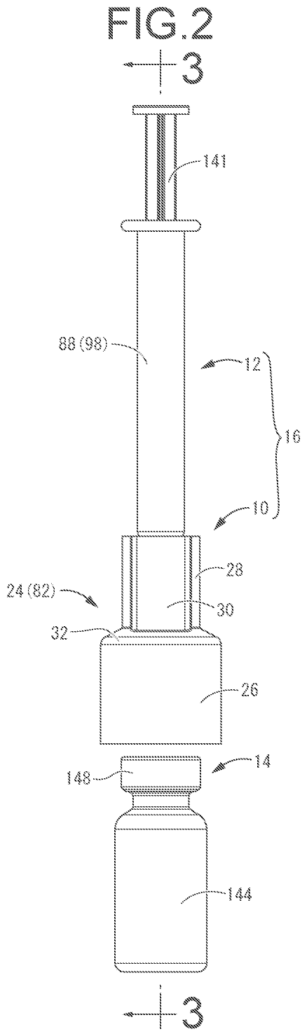

FIGS. 1 to 4 show a coupler 10 as a first practical embodiment of the present invention. This coupler 10 couples a syringe 12 containing a solution or the like and a vial 14 containing a powder preparation or the like with each other. FIGS. 1 to 4 show a drug preparation device 16 with the syringe 12 attached to the coupler 10 in its initial state before the vial 14 is attached. In the following description, the axial direction refers to the needle axis direction of a transfusion needle 22 described below, which is provided in the coupler 10, as well as to the center axis direction of a housing member 24 described below, which is approximately tubular and houses the transfusion needle 22, and coincides with the vertical direction in FIG. 2. The vertical direction refers to the vertical direction in FIG. 2, but the direction in which the coupler 10 is actually used is not limited to the vertical direction or any other direction.

Described more specifically, the coupler 10 includes a syringe attachment part 18 to which the syringe 12 is detachably attached, a vial attachment part 20 to which the vial 14 is attached, and a transfusion needle 22, which is a double-ended needle, for placing the syringe 12 and the vial 14 in communication with each other. The coupler 10 includes an approximately tubular housing member 24 that houses the transfusion needle 22 inside. A first axial opening side (an upper opening 25a side) of the housing member 24 serves as the syringe attachment part 18 to which the syringe 12 can be attached, and a second axial opening side (a lower opening 25b side) of the housing member 24 serves as the vial attachment part 20 to which the vial 14 can be attached.

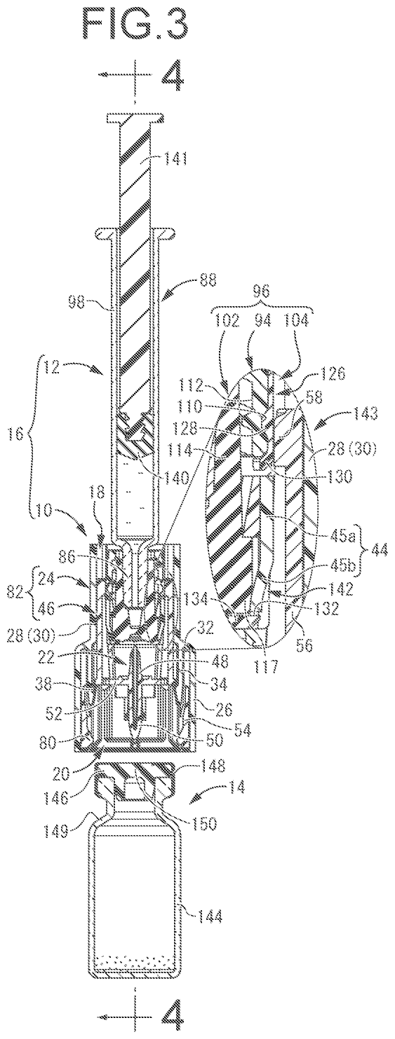

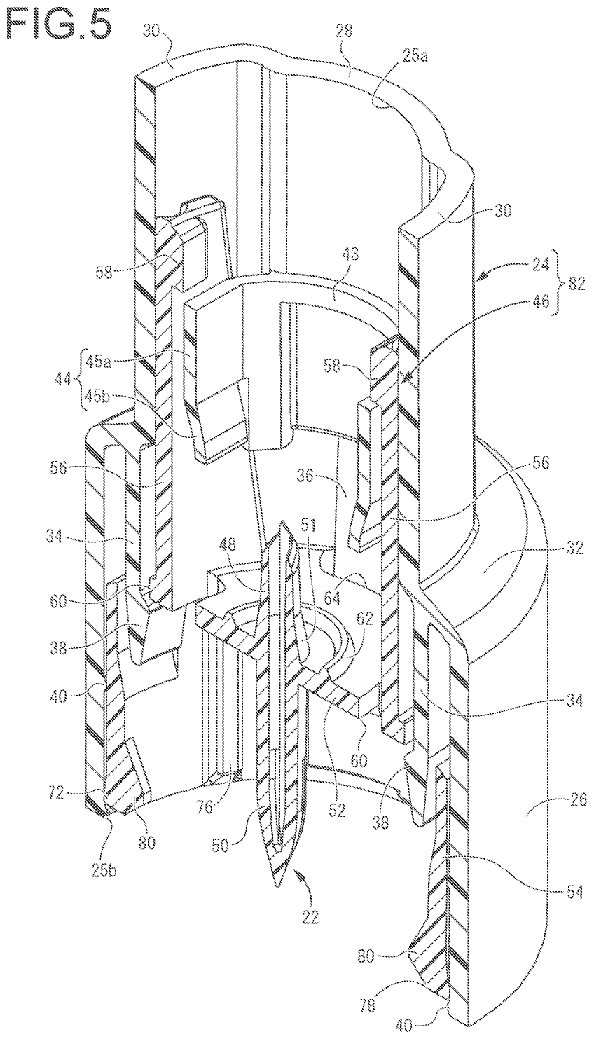

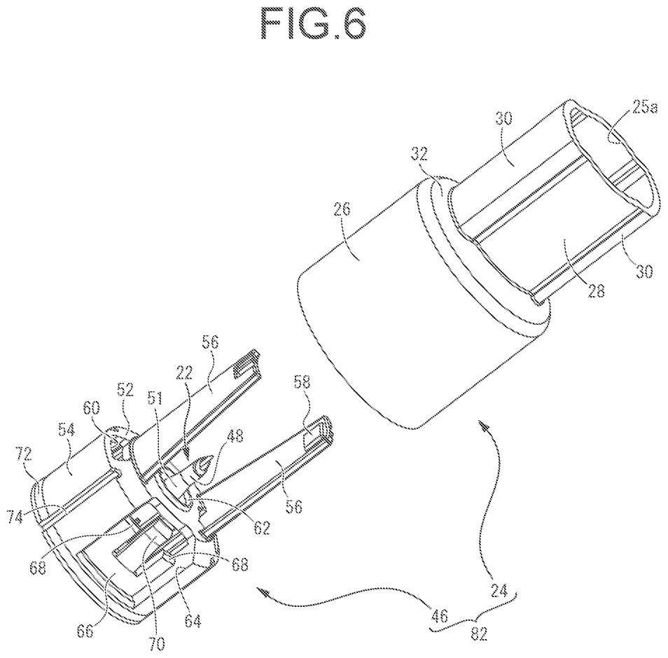

As shown in FIGS. 5 to 7, the housing member 24 is integrally molded from a synthetic resin, and has a stepped tubular shape with the lower side being a large-diameter tube part 26 that is larger in diameter than the upper side, while the upper side being a small-diameter tube part 28 that is smaller in diameter than the large-diameter tube part 26. In this practical embodiment, the large-diameter tube part 26 has an approximately round tubular shape, while the small-diameter tube part 28 has a shape in which radially opposite sides (the opposite sides in the left-right direction in FIG. 3) of a round tubular peripheral wall bulge outward. That is, the small-diameter tube part 28 includes bulging parts 30, 30 that bulge outward on the two sides opposed to each other along an axis in the diametrical direction, and in the small-diameter tube part 28, the inner and outer diameter dimensions are partially made larger at the portions where the bulging parts 30, 30 are formed. The large-diameter tube part 26 and the small-diameter tube part 28 are coupled by an annular wall part 32. In this practical embodiment, the annular wall part 32 slightly slopes downward toward the radially outer side. The size and shape of the housing member 24 can be changed as appropriate depending on the vial 14 configured to be attached to the housing member 24.

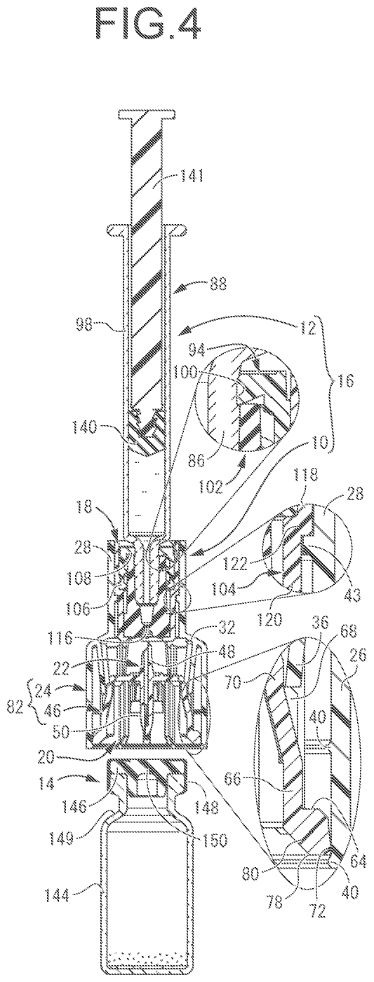

The inner circumferential portion of the annular wall part 32 is provided with a pair of first elastic pieces 34, 34 each projecting downwardly and being opposed to each other in the diametrical direction, and a pair of second elastic pieces 36, 36 each projecting downwardly and being opposed to each other in the diametrical direction. The direction of opposition of the first elastic pieces 34, 34 and the direction of opposition of the second elastic pieces 36, 36 are mutually different, and in this practical embodiment, the direction of opposition of the first elastic pieces 34, 34 and the direction of opposition of the second elastic pieces 36, 36 are mutually orthogonal. That is, in this practical embodiment, the first elastic pieces 34, 34 are opposed to each other in the left-right direction in FIG. 3, and the second elastic pieces 36, 36 are opposed to each other in the left-right direction in FIG. 4. Regarding the first elastic piece and the second elastic piece, three or more of them may be provided, and for example, they may be mutually spaced apart in the circumferential direction at roughly equal intervals.

The protrusion distal end portions (the lower end portions) of the first elastic pieces 34, 34 are provided with locking claws 38, 38 protruding radially inward. As shown in FIG. 4, in the initial state of the drug preparation device 16 before the vial 14 is attached, the second elastic pieces 36, 36 slope radially inward toward the bottom. These first elastic pieces 34, 34 and second elastic pieces 36, 36 have a certain degree of circumferential dimension and vertical dimension, and in this practical embodiment, they extend near to the vertically center portion of the large-diameter tube part 26. The first elastic pieces 34, 34 and the second elastic pieces 36, 36 are relatively thin-walled and can be elastically deformed in the diametrical direction (the left-right direction in FIG. 3 and the left-right direction in FIG. 4 respectively).

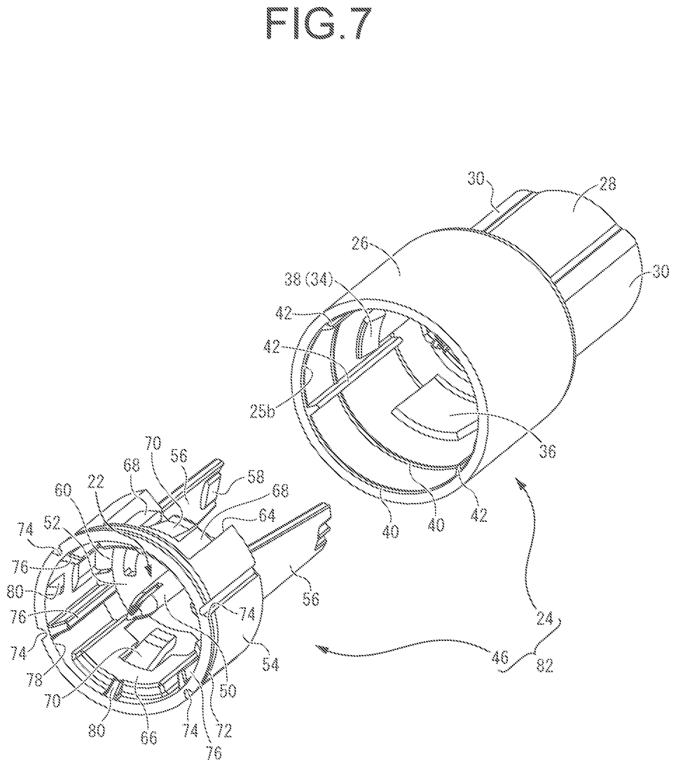

Furthermore, as shown in FIG. 7, the inner circumferential surface of the large-diameter tube part 26 is provided with circumferential ribs 40 extending in the circumferential direction. In this practical embodiment, two circumferential ribs 40, 40 are provided axially separated from each other. One circumferential rib 40 is provided at the lower end of the large-diameter tube part 26 (the lower opening 25b), and the other circumferential rib 40 is provided at the position separated upwardly from the lower end of the large-diameter tube part 26. These circumferential ribs 40, 40 are provided on the inner circumferential surface of the large-diameter tube part 26 about approximately the entire circumference, but may be provided partially in the circumferential direction.

Furthermore, the inner circumferential surface of the large-diameter tube part 26 is provided with a plurality of axial ribs 42 extending in the axial (vertical) direction, and in this practical embodiment, they are provided across approximately the entire vertical length of the large-diameter tube part 26. In this practical embodiment, the axial ribs 42 are provided circumferentially between the first elastic piece 34 and the second elastic piece 36, and four axial ribs 42 are provided in the large-diameter tube part 26. The number of the axial ribs 42 is not limited to four, but it is preferable that a plurality of the axial ribs 42 be provided. The cross-sectional shapes of the circumferential ribs 40 and the axial ribs 42 are not limited, but in this practical embodiment, they have an approximately mountainous cross-sectional shape that becomes narrower toward the radially inner side.

As shown in FIG. 5, the small-diameter tube part 28 is provided with an inside wall part 43 on its radially inner side. Such an inside wall part 43 is formed as a convex part protruding from the inner circumferential surface of the small-diameter tube part 28 and extending in the circumferential direction at the peripheral wall portions other than the bulging parts 30, 30, while at the peripheral wall portions of the bulging parts 30, 30, the inside wall part 43 is formed as an inner circumferential wall part separated radially inward from the inner circumferential surface of the small-diameter tube part 28 and extending in the circumferential direction.

In the inside wall part 43, the inner circumferential wall parts located on the respective inner sides of the bulging parts 30, 30 serve as elastic locking pieces 44, 44 extending downwardly. The protrusion proximal end portions 45a, 45a (the upper portions of the inside wall part 43) of these elastic locking pieces 44, 44 have an approximately flat-plate shape and spread out in the vertical direction, while the protrusion distal end portions 45b, 45b (the lower portions of the inside wall part 43) of the elastic locking pieces 44, 44 slope inward in the direction of opposition. The protrusion distal end portions 45b, 45b of the elastic locking pieces 44, 44 are elastically deformable in the direction of opposition (the left-right direction in FIG. 3).

The transfusion needle 22 housed in the housing member 24 is held by a needle holding member 46 that is attached to the housing member 24 movably in the axial direction. In this practical embodiment, the transfusion needle 22 and the needle holding member 46 are integrally formed of a synthetic resin.

The transfusion needle 22, which is a double-ended needle, extends straight in the vertical direction, and includes an upper projection 48 projecting toward the syringe 12 and a lower projection 50 projecting toward the vial 14. The ends of these upper projection 48 and lower projection 50 are sharply pointed. As shown in FIGS. 3 to 7, the transfusion needle 22 is hollow, and in this practical embodiment, the opening on the syringe 12 side is formed like a tapered blade surface at the upper end portion of the upper projection 48, while the opening on the vial 14 side opens onto the conical outer circumferential surface of the lower end portion of the lower projection 50. However, the specific shape of the transfusion needle 22 is not limited. In particular, in this practical embodiment, the upper projection 48 has a tapered part 51 whose outer diameter dimension gradually increases downwardly in the lower portion. As described below, when the upper projection 48 of the transfusion needle 22 punctures an obstruction part 116 of a cap 102, the tapered part 51 abuts against the inner circumferential surface of the lower end portion of the cap 102, thereby reliably obtaining airtightness between the transfusion needle 22 and the cap 102.

Besides, the needle holding member 46 includes an annular bottom wall part 52 projecting radially outward from the vertically center portion of the transfusion needle 22, and an approximately tubular peripheral wall part 54 projects downwardly from the outer peripheral edge of the said bottom wall part 52. In other words, the upper projection 48 and the lower projection 50 of the transfusion needle 22 protrude from the center portion of the bottom wall part 52 to the opposite sides in the vertical direction.

In the radially middle portion of the bottom wall part 52, a pair of arm parts 56, 56 opposed to each other in the radial direction (the right-left direction in FIG. 3) protrude upwardly, and the protrusion distal ends (the upper ends) of the two arm parts 56, 56 are provided with deformation limiting parts 58, 58. The deformation limiting parts 58, 58 protrude inwardly in the direction of opposition and limit radially outward deformation of elastic engaging parts 126, 126 of a cap holder 104, which is described later. The arm parts 56, 56 are curved along the circumferential direction of the bottom wall part 52, and the inner surfaces of the deformation limiting parts 58, 58 in the direction of opposition are not curved but are approximately flat.

In the bottom wall part 52, insertion holes 60, 60 are formed on the radially outer side of the arm parts 56, 56, which pass through the bottom wall part 52 in the vertical direction. Each of the insertion holes 60, 60 has a certain degree of width dimension (a dimension in the radial direction of the bottom wall part 52) and a certain degree of length dimension (a dimension in the circumferential direction of the bottom wall part 52). Furthermore, on the top surface of the bottom wall part 52, an annular fitting protrusion 62 is provided radially between the transfusion needle 22 and the arm part 56.

Furthermore, on the opposite sides of the peripheral wall part 54 and the bottom wall part 52 in a direction orthogonal to the direction of opposition of the two arm parts 56, 56 (the opposite sides in the left-right direction in FIG. 4), accommodation regions 64, 64 are formed so as to open to the radially outward and upward over a predetermined circumferential region. Base walls 66, 66 of these accommodation regions 64, 64 are located on radially inner side of the peripheral wall part 54, and the upper portions of the base walls 66, 66 and the bottom wall part 52 are penetrated in the thickness direction. With this configuration, the accommodation regions 64, 64 open above. The circumferentially opposite sides of the upper end portion of the base wall 66 constitute abutting parts 68, 68 that abut against the second elastic piece 36 of the housing member 24 in the initial state before the vial 14 is attached.

In addition, circumferentially between the abutting parts 68, 68, an elastic contact piece 70 is provided so as to project upward and be spaced apart from the abutting parts 68, 68 in the circumferential direction. This elastic contact piece 70 protrudes above the abutting parts 68, 68 at the upper end of the base wall 66, and is elastically deformable in the thickness direction (the radial direction of the bottom wall part 52). The protrusion proximal end portion (the lower portion) of the elastic contact piece 70 slopes radially inward toward the top, while the protrusion distal end portion (the upper portion) projects straight upward. As shown in FIG. 4, in the initial state before the vial 14 is attached, the second elastic piece 36 of the housing member 24 comes into contact with and abuts against the abutting parts 68, 68 of the base wall 66 in an approximately vertical direction. Meanwhile, the protrusion distal end portion of the elastic contact piece 70, which is located circumferentially between the abutting parts 68, 68, abuts against the second elastic piece 36 of the housing member 24 from the radially inner side or is slightly separated therefrom to the radially inner side.

Moreover, at the lower end of the outer circumferential surface of the peripheral wall part 54, an outer circumferential protrusion 72 is provided so as to protrude radially outward and extend in the circumferential direction. This outer circumferential protrusion 72 is provided over the entire circumference in the circumferential direction. Besides, the outer circumferential protrusion 72 can engage with the circumferential rib 40 of the large-diameter tube part 26 of the housing member 24 when the housing member 24 and the needle holding member 46 are assembled, as described below. In addition, the outer circumferential surface of the portion above the outer circumferential protrusion 72 in the peripheral wall part 54 is configured approximately not to touch the inner circumferential surface of the large-diameter tube part 26. Also, the vertical dimension of the outer circumferential protrusion 72 is sufficiently small. Thus, even in a state where the outer circumferential protrusion 72 and the inner circumferential surface of the large-diameter tube part 26 abut against each other, the friction due to their abutment is sufficiently small, so that the needle holding member 46 is movable with respect to the housing member 24.

Furthermore, on the outer circumferential surface of the peripheral wall part 54, axial grooves 74 are provided at positions corresponding circumferentially to the axial ribs 42 of the housing member 24. Hence, in this practical embodiment, four axial grooves 74 are provided on the outer circumferential surface of peripheral wall part 54. The cross-sectional shape of these axial grooves 74 is made approximately equal to that of the axial ribs 42 of the large-diameter tube part 26 of the housing member 24, and the axial grooves 74 are formed across approximately the entire vertical length of the peripheral wall part 54. With this configuration, when the housing member 24 and the needle holding member 46 are assembled as described below, the axial ribs 42 can enter the respective axial grooves 74, and the needle holding member 46 is axially movable along the axial ribs 42, while the needle holding member 46 is prevented from rotating with respect to the housing member 24.

Besides, on the inner circumferential surface of peripheral wall part 54, axial ribs 76 are provided at positions corresponding circumferentially to the axial grooves 74 on the outer circumferential surface. That is, in this practical embodiment, four axial ribs 76 are provided on the inner circumferential surface of the peripheral wall part 54. These axial ribs 76 are provided across approximately the entire axial length of the peripheral wall part 54. The axial ribs 76 protrude radially inward from the inner circumferential surface of the peripheral wall part 54, and the inner circumferential surface of the axial ribs 76 is at approximately the same position as the inner circumferential surface of the base wall 66 in the radial direction of the bottom wall part 52. With this configuration, when inserting the vial 14 from a lower opening 78 of the peripheral wall part 54 (the needle holding member 46) as described below, a ring-shaped member 148 (described later), which is located on the radially outer side in the vial 14, abuts against the inner circumferential surfaces of the base wall 66 and the axial rib 76. This allows the vial 14 to be inserted into the needle holding member 46 (the drug preparation device 16) from below without tilting.

Moreover, at the lower end of the inner circumferential surface of the peripheral wall part 54, between the circumferentially adjacent axial ribs 76, 76, an inward projection 80 is provided so as to protrude radially inward. A total of four inward projections 80 are provided on the opposite sides in the direction of opposition of the arm parts 56, 56 (the opposite sides in the left-right direction in FIG. 3) and on the opposite sides in the direction of opposition of the elastic contact pieces 70, 70 (the opposite sides in the left-right direction in FIG. 4) in the needle holding member 46. In particular, the inward projections 80, 80 provided on the opposite sides in the left-right direction in FIG. 4 are formed so as to be continuous with the base walls 66, 66 of the accommodation regions 64, 64. The lower surfaces of the axial ribs 76 and the inward projections 80, which are spaced apart at roughly equal intervals in the circumferential direction, slope upwardly toward the radially inner side. Thus, when the vial 14 is inserted from below into the needle holding member 46 (the drug preparation device 16), as described below, the vial 14 will be guided to the center of a transfusion needle unit 82, and the central axis of the vial 14 and the needle axis of the transfusion needle 22 will be aligned with each other.

In this practical embodiment, the transfusion needle unit 82 is configured by mutually assembling the housing member 24 and the needle holding member 46. That is, the needle holding member 46 is inserted from the lower opening 25b of the housing member 24, and the arm parts 56, 56 of the needle holding member 46 are inserted into the bulging parts 30, 30 through the gap between the bulging parts 30, 30 and the elastic locking pieces 44, 44 of the small-diameter tube part 28 of the housing member 24. In the initial state before the vial 14 is attached, the deformation limiting parts 58, 58 provided on the arm parts 56, 56 are located above the elastic locking pieces 44, 44 of the housing member 24. Besides, the first elastic pieces 34, 34 of the housing member 24 are inserted into the insertion holes 60, 60 of the needle holding member 46 from above, and the locking claws 38, 38 are located below the bottom wall part 52. The axial rib 42 of the housing member 24 is inserted into the axial groove 74 of the needle holding member 46.

Furthermore, the second elastic pieces 36, 36 of the housing member 24 are inserted from above into the accommodation regions 64, 64 of the needle holding member 46. The upper end surfaces of the abutting parts 68, 68 come into contact with the protrusion distal end of the second elastic piece 36 in an approximately vertical direction, while the protrusion distal end portion of the elastic contact piece 70 abuts against the inner circumferential surface of the second elastic piece 36 or is slightly separated therefrom. This prevents the needle holding member 46 from moving upward with respect to the housing member 24. Moreover, the outer circumferential protrusion 72 of the needle holding member 46 climbs over the circumferential rib 40 of the lower opening 25b of the housing member 24 and engages with the circumferential rib 40 from above. This prevents the needle holding member 46 from moving downward with respect to the housing member 24. As a result, in the initial state before the vial 14 is attached, the needle holding member 46 is attached to the housing member 24 while being positioned in the vertical direction with respect to the housing member 24.

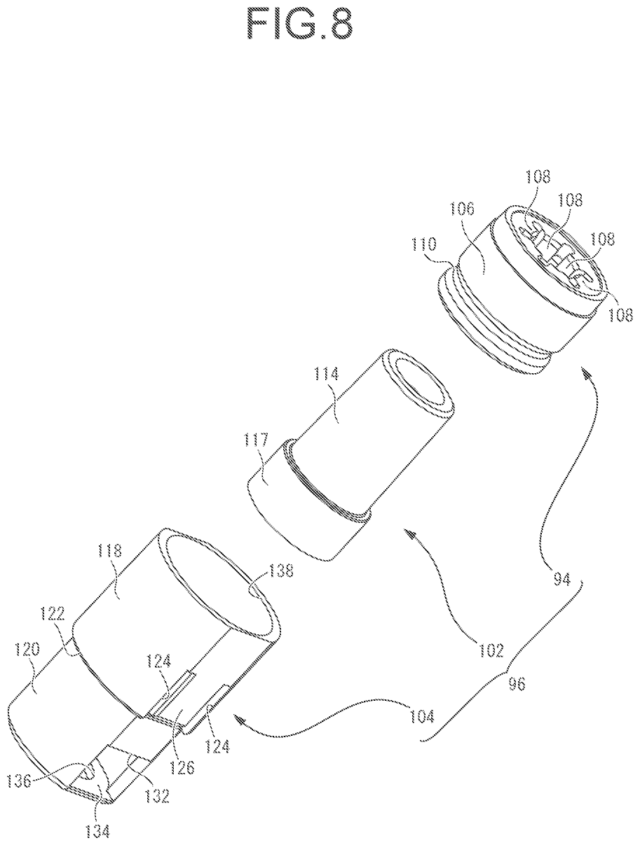

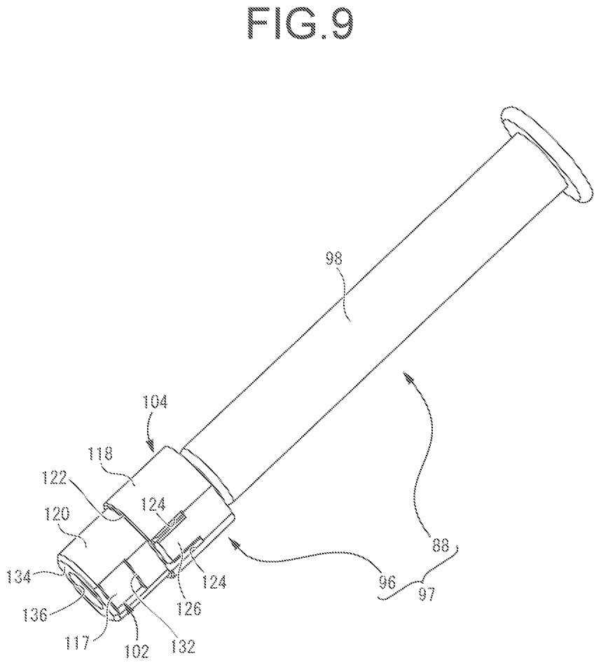

In the drug preparation device 16 of this practical embodiment, the syringe 12 is attached from the upper opening 25a of the transfusion needle unit 82. The syringe 12 of this practical embodiment comprises a syringe main body 88 having a nozzle part 86 at the distal end (the lower end), and a lock collar 94 that is made of synthetic resin and is provided to the nozzle part 86. The material of the syringe main body 88 is not limited, but in this practical embodiment, the syringe main body 88 is formed of glass. A cap unit 96 shown in FIG. 8, etc. is attached to the syringe main body 88 to constitute a nest syringe 97 shown in FIG. 9.

The syringe main body 88 includes a barrel part 98, and the nozzle part 86 whose outer and inner diameter dimensions are smaller than those of the barrel part 98 is provided at the distal end (the lower end) of the barrel part 98. As shown in FIG. 4, an annular recess 100 opening radially outward is formed at the proximal end portion (the upper end portion) of the nozzle part 86. With this configuration, the outer diameter dimension of the nozzle part 86 at the position where the annular recess 100 is formed is smaller than the outer diameter dimensions of the portions vertically adjacent to the annular recess 100. The nozzle part 86 has an outer diameter dimension gradually decreasing from the proximal end to the distal end.

As shown in FIG. 8, the cap unit 96 is constituted by assembling the lock collar 94, the cap 102 that covers the nozzle part 86 of the syringe 12, and the cap holder 104 that is made of synthetic resin and holds the cap 102.

The lock collar 94 has an approximately round tubular shape overall, and includes a peripheral wall 106. Locking parts 108 protruding radially inward are provided at one axial opening (the upper opening) of the peripheral wall 106. In this practical embodiment, six locking parts 108 are provided on the circumference so as to be spaced apart from one another at roughly equal intervals in the circumferential direction. In addition, a concave groove 110, which opens radially outward and extends in the circumferential direction, is formed in the axially middle portion on the outer circumferential surface of the peripheral wall 106. In this practical embodiment, the concave groove 110 is formed over approximately the entire circumference in the circumferential direction, so that the concave groove 110 has a generally annular shape. In particular, in this practical embodiment, the annular concave groove 110 is provided on the other axial side (the lower side) of the peripheral wall 106. Besides, a female thread 112 is formed on the inner circumferential surface of the peripheral wall 106.

The cap 102 has an approximately round tubular shape overall, and is formed of an elastic body such as rubber. The cap 102 includes a peripheral wall 114, and the inner diameter dimension of the peripheral wall 114 gradually decreases from one axial side (the upper side) to the other axial side (the lower side). The maximum inner diameter dimension of the peripheral wall 114 (the inner diameter dimension of the upper end) is smaller than the outer diameter dimension of the distal end portion of the nozzle part 86. The other axial opening of the peripheral wall 114 is obstructed by the obstruction part 116, which is integrally formed with the peripheral wall 114 and extends in the axis-perpendicular direction. The thickness dimension (the vertical dimension) of the obstruction part 116 is relatively small. On the other axial side of the peripheral wall 114, provided is a thick-walled part 117 that has an enlarged outer diameter dimension and is thicker than the one axial side thereof.

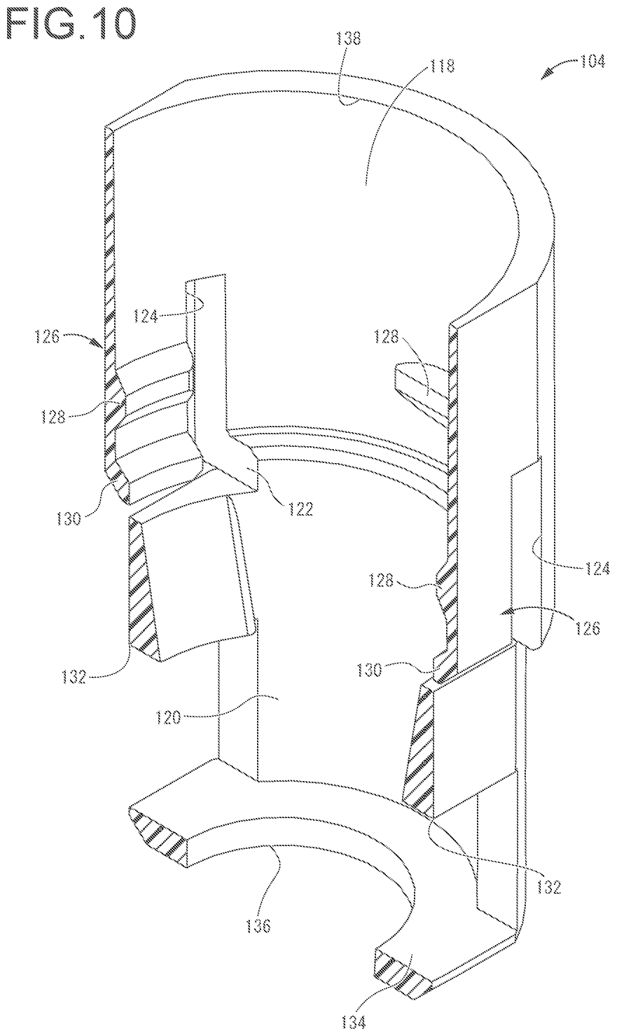

As shown in FIG. 10, the cap holder 104 has an approximately stepped tubular shape, with one axial side being a large-diameter part 118 and the other axial side being a small-diameter part 120. Specifically, an annular stepped part 122 extending in the axis-perpendicular direction is formed in the axially middle portion of the cap holder 104, and the large-diameter part 118 and the small-diameter part 120 are connected by the stepped part 122. The large-diameter part 118 and the small-diameter part 120 have an approximately the same external shape as each other, and are shaped as if the opposite sides of a round tube in one diametrical direction (the opposite sides in the left-right direction in FIG. 3) were partially cut off. With this configuration, in the large-diameter part 118 and the small-diameter part 120, the opposite sides in the left-right direction in FIG. 3 are flat surfaces spreading in the vertical direction, and the opposite sides in the left-right direction in FIG. 4 are curved surfaces.

In the large-diameter part 118, slits 124 are formed at the boundary portions between the flat surface and the curved surface. Each slit 124 extends from the lower end with a certain degree of axial length and penetrates the large-diameter part 118 in the thickness direction. In each portion where the flat surface is formed on the peripheral wall of the large-diameter part 118, an elastic engaging part 126 serving as an engaging part is defined circumferentially between the two slits 124, 124. Each elastic engaging part 126 is elastically deformable in the thickness direction of the peripheral wall of the large-diameter part 118 (the left-right direction in FIG. 3). The elastic engaging part 126 has a certain degree of length dimension (a vertical dimension) and a certain degree of width dimension (a circumferential dimension between the two slits 124, 124). The lengthwise middle portion of the inner surface of each elastic engaging part 126 is provided with an engaging convex part 128 projecting radially inward, and the lower end of each elastic engaging part 126 is provided with an engaging claw part 130, which slopes and projects inward in the direction of opposition (the left-right direction in FIG. 3) toward the bottom.

In this practical embodiment, the engaging convex part 128 is also formed on the inner surface of the portion of the peripheral wall of the large-diameter part 118 where the curved surface is formed (the opposite sides in the left-right direction in FIG. 4). However, the engaging convex part 128 formed on the peripheral wall inner surface of the large-diameter part 118 is different in size and shape compared to the engaging convex part 128 formed on the inner surface of the elastic engaging part 126. That is, the engaging convex part 128 formed on the inner surface of the elastic engaging part 126 has a relatively large protruding height and is formed with an approximately constant cross-sectional shape (the protruding height) in the circumferential direction along the arcuately curved inner circumferential surface of the elastic engaging part 126. On the other hand, regarding the engaging convex part 128 formed on the peripheral wall inner surface of the large-diameter part 118, the maximum protruding height is slightly smaller, and the apex of the convex part does not extend not along the inner circumferential surface of the peripheral wall but extends linearly in the tangential direction of the peripheral wall, thereby minimizing the protruding volume.

In the peripheral wall of the small-diameter part 120, approximately rectangular through windows 132, which penetrate the small-diameter part 120 in the thickness direction in the lower portion, are formed in the portions where the flat surfaces are formed on the opposite sides in the diametrical direction (the opposite sides in the left-right direction in FIG. 3). The inner diameter dimension of the small-diameter part 120 is slightly smaller than the outer diameter dimension of the thick-walled part 117 of the cap 102, so that when the cap 102 and the cap holder 104 are assembled, the thick-walled part 117 is press-fitted into the cap holder 104 while being compressed radially inward. Besides, the vertical dimension of the through window 132 is approximately equal to or slightly larger than the vertical dimension of the thick-walled part 117, so that when the cap 102 and cap holder 104 are assembled, the thick-walled part 117 is partially deformed to recover, so as to enter the through window 132, as shown in FIG. 3. For example, the vertical dimension of the through window 132 may be made slightly smaller than the vertical dimension of the thick-walled part 117, so that the thick-walled part 117 entering into the through window 132 is compressed in the vertical direction as well by the inner surface of the through window 132.

Furthermore, the lower end of the small-diameter part 120 is provided with a bottom plate 134 that extends in the axis-perpendicular direction, and a through hole penetrates the center of the bottom plate 134 in the vertical direction. The through hole constitutes a lower opening 136 of the cap holder 104.

The order in which these lock collar 94, cap 102, and cap holder 104 are assembled is not limited, but for example, the cap 102 is inserted from the upper opening 138 of the cap holder 104 (the upper opening of the large-diameter part 118). As mentioned above, the thick-walled part 117 of the cap 102 is inserted in a press-fitted state into the small-diameter part 120 of the cap holder 104, and the thick-walled part 117 partially enters the through window 132, thereby positioning the cap 102 with respect to the cap holder 104 in the vertical direction.

Then, the lock collar 94 is inserted from the upper opening 138 of the cap holder 104. At that time, the lower end of the lock collar 94 pushes the engaging convex parts 128, 128 of the elastic engaging parts 126, 126 radially outward, and the lower end of the lock collar 94 climbs over the engaging convex parts 128, 128. This causes the elastic engaging parts 126, 126 to deform to recover, so that the concave groove 110 of the lock collar 94 and the engaging convex parts 128, 128 of the cap holder 104 come into convexo-concave engagement. This restricts insertion of the lock collar 94 into the cap holder 104. Besides, as shown in FIG. 3, the lower end of the peripheral wall 106 of the lock collar 94 abuts against the engaging claw parts 130, 130 of the elastic engaging parts 126, 126 in the vertical direction. By the lower end of the lock collar 94 abutting against the engaging claw parts 130, 130 of the elastic engaging parts 126, 126 and the stepped part 122, further insertion of the lock collar 94 into the cap holder 104 can also be restricted.

The vertical positioning of the cap 102 and the cap holder 104 may be performed, for example, by the lock collar 94 being attached to the cap holder 104. That is, the peripheral wall 114 of the cap 102 may be clasped vertically between the locking part 108 of the lock collar 94 and the bottom plate 134 of the cap holder 104. Besides, the lock collar 94 and the cap 102 may be assembled so that the upper end of the peripheral wall 114 of the cap 102 is inserted into the peripheral wall 106 of the lock collar 94. For example, the upper end of the peripheral wall 114 of the cap 102 may be supported by the mountain part of the female thread 112 provided on the inner circumferential surface of the peripheral wall 106 of the lock collar 94. Then, such an assembly of the lock collar 94 and the cap 102 may be inserted from the upper opening 138 of the cap holder 104 to assemble the lock collar 94, the cap 102, and the cap holder 104.

The nozzle part 86 of the syringe 12 is inserted from above into the cap unit 96 assembled in the above manner, and the locking part 108 of the lock collar 94 is locked in the annular recess 100 provided in the nozzle part 86, so that the cap unit 96 is attached to the syringe main body 88 to constitute the nest syringe 97. With this configuration, the lock collar 94, which is a separate component from the syringe main body 88, is fixedly attached to the nozzle part 86 of the syringe main body 88. Since the outer diameter dimension of the nozzle part 86 of the syringe main body 88 is larger than the inner diameter dimension of the cap 102 of the cap unit 96, the nozzle part 86 is inserted into the cap 102 in a press-fitted state, and the opening of the syringe main body 88 on the distal end side (the nozzle part 86 side) is liquid-tightly sealed by the cap 102 in a liquid-tight manner.

Then, the cap unit 96 of the nest syringe 97 is inserted from the upper opening 25a of the transfusion needle unit 82 to be attached. Prior to insertion of the cap unit 96 into the transfusion needle unit 82, the syringe main body 88 is filled with a solution or the like for drug preparation, and the opening of the syringe main body 88 on the proximal end side is liquid-tightly sealed by a gasket 140. In such an assembly of the transfusion needle unit 82 and the nest syringe 97, by attaching a plunger 141 to the gasket 140 by screwing or the like, the drug preparation device 16 of the present practical embodiment is configured.

When inserting the cap unit 96 into the transfusion needle unit 82, the cap unit 96 is inserted in a state where the portion of the small-diameter tube part 28 of the housing member 24, which has no bulging part 30 and arcuately curves, and the curved surface of the large-diameter part 118 of the cap holder 104, are overlapped with each other in the radial direction. This makes it possible to perform the insertion operation while keeping track of the circumferential orientation of the transfusion needle unit 82 and the cap unit 96.

Here, the distance between the protrusion distal end portions 45b, 45b of the elastic locking pieces 44, 44 of the housing member 24 (the left-right dimension in FIG. 3) is smaller than the width dimension of the bottom plate 134 of the cap holder 104 (the left-right dimension in FIG. 3). Thus, due to the cap unit 96 being inserted into the transfusion needle unit 82, the protrusion distal end portions 45b, 45b of the elastic locking pieces 44, 44 are elastically deformed radially outward (outward in the left-right direction in FIG. 3).

Then, the protrusion distal end portions 45b, 45b is elastically deformed to recover by climbing over the bottom plate 134, so that the protrusion distal end portions 45b, 45b of the elastic locking pieces 44, 44 are inserted into the through windows 132, 132 of the cap holder 104. By so doing, the bottom plate 134 is positioned below the protrusion distal end portions 45b, 45b of the elastic locking pieces 44, 44, and by the protrusion distal end portions 45b, 45b and the bottom plate 134 abutting against each other, the cap unit 96 (the syringe 12) is prevented from moving upward with respect to the transfusion needle unit 82. In such a state where the protrusion distal end portions 45b, 45b are inserted in the through windows 132, 132, the outer circumferential surface of the elastic engaging part 126 and the outer circumferential surface of the elastic locking piece 44 are at approximately the same radial position and are approximately continuous with each other in the vertical direction.

Specifically, in the housing member 24 of this practical embodiment, on the opening side (the upper opening 25a side) where the syringe 12 can be attached, there is provided a first locking mechanism 142 that permits insertion of the cap 102 and the cap holder 104 while preventing their detachment. In short, as shown in FIG. 3, the insertion of the cap 102 and the cap holder 104 is permitted by the protrusion distal end portions 45b, 45b of the elastic locking pieces 44, 44 of the housing member 24 elastically deforming radially outward, while their detachment is prevented by the protrusion distal end portions 45b, 45b abutting against the bottom plate 134 of the cap holder 104. Thus, the first locking mechanism 142 comprises the protrusion distal end portions 45b, 45b of the elastic locking pieces 44, 44. In other words, in this practical embodiment, in the syringe attachment part 18 of the housing member 24, the cap 102 is held in an attached state to the nozzle part 86 of the syringe 12 by the first locking mechanism 142 (the protrusion distal end portions 45b, 45b) via the cap holder 104.

In the direction orthogonal to the direction of opposition of the elastic locking pieces 44 (the left-right direction in FIG. 4), the inside wall part 43 of the housing member 24 and the stepped part 122 in the cap holder 104 are vertically overlapped and in contact with each other. This restricts further insertion of the cap unit 96 (the syringe 12) into the transfusion needle unit 82, namely, the downward movement of the cap unit 96 with respect to the transfusion needle unit 82 is prevented. As a result, the transfusion needle unit 82 and the cap unit 96 (the syringe 12) are mutually positioned in the vertical direction.

In such an assembled state of the transfusion needle unit 82 and the cap unit 96, the deformation limiting parts 58, 58 provided on the arm parts 56, 56 of the needle holding member 46 are located on the radially outer side of the engaged portion between the cap holder 104 and the lock collar 94, that is, the engaged portion between the engaging convex part 128 and the concave groove 110. Since the wall parts comprising the bulging parts 30, 30 of the small-diameter tube part 28 in the housing member 24 are located on the radially outer side of the arm parts 56, 56, radially outward deformation of the arm parts 56, 56 is prevented, which in turn prevents radially outward deformation of the elastic engaging parts 126, 126 of the cap holder 104. As a result, the convexo-concave engagement between the engaging convex part 128 and the concave groove 110 is maintained, and the cap unit 96 (the syringe 12) is prevented from being detached from the transfusion needle unit 82. That is, the coupler 10 (the drug preparation device 16) of this practical embodiment is provided with a holding mechanism 143 (see FIG. 3) that holds the elastic engaging parts 126, 126 (the engaging convex parts 128, 128) serving as the engaging parts in an engaged state with the concave groove 110 of the lock collar 94. In particular, in this practical embodiment, the holding mechanism 143 comprises the deformation limiting parts 58, 58 that are arranged on the radially outer side of the elastic engaging parts 126, 126 to limit the radially outward deformation of the elastic engaging parts 126, 126, thereby holding the elastic engaging parts 126, 126 in an engaged state with the outer circumferential surface (the concave groove 110) of the lock collar 94.

The vial 14 is attached to the vial attachment part 20 in the lower opening 25b of the drug preparation device 16 as described above. In this practical embodiment, the vial 14 includes a bottle-shaped vial main body 144, a lid member 146 made of an elastic body such as rubber that seals the opening of the vial main body 144, and a ring-shaped member 148 that fixes the vial main body 144 and the lid member 146 by caulking from the radially outer side. The vial main body 144 is provided with a constricted part 149 with a reduced outer diameter dimension at a position separated downwardly from the upper end. By the lower end of the ring-shaped member 148 being overlapped on the constricted part 149, the lid member 146 is liquid-tightly attached to the vial main body 144. In the center of the lid member 146, provided is a thin-walled part 150 that is thinner than the other portions of the lid member 146. The vial 14 contains the powder preparation for drug preparation before the opening is sealed by the lid member 146.

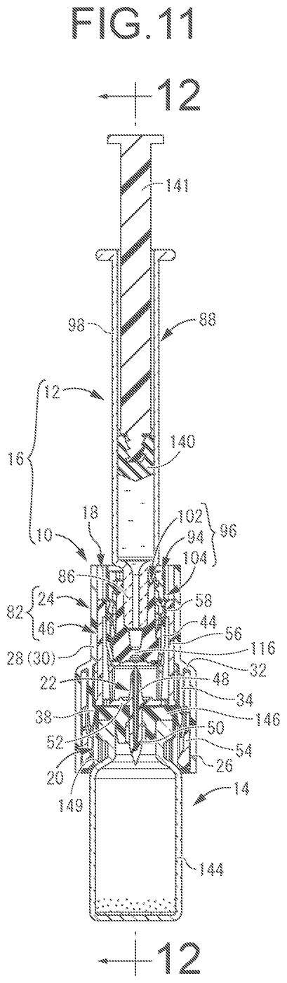

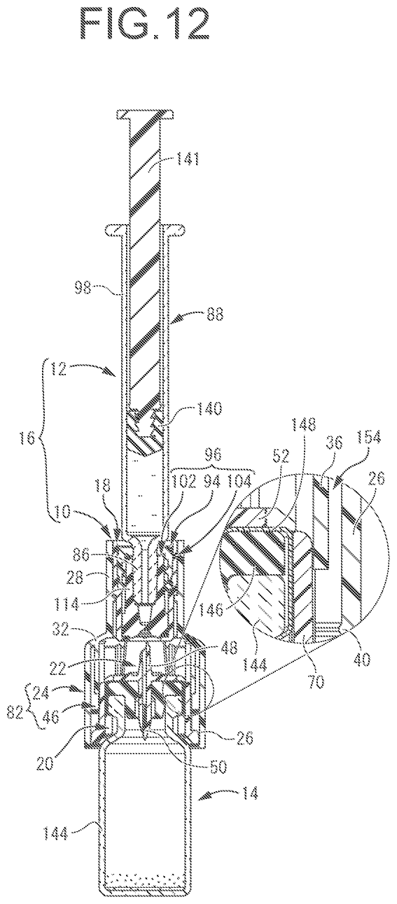

To attach the vial 14 to the drug preparation device 16, the vial 14 is first brought closer to the lower opening 25b of the drug preparation device 16. In the lower opening 25b of the drug preparation device 16, the lower surfaces of both the axial rib 76 and the inward projection 80 of the needle holding member 46 slope upwardly toward the radially inner side. Thus, the vial 14 is guided into the center of the needle holding member 46 by these axial ribs 76 and inward projection 80, and the lower projection 50 of the transfusion needle 22 and the thin-walled part 150 of the lid member 146 of the vial 14 are aligned in the vertical direction. Then, by further pushing and inserting the vial 14 into the drug preparation device 16, the lower projection 50 of the transfusion needle 22 punctures and penetrates the thin-walled part 150, as shown in FIGS. 11 and 12.

During insertion of the vial 14 into the drug preparation device 16 and puncturing the thin-walled part 150 with the lower projection 50 of the transfusion needle 22, the second elastic pieces 36 of the housing member 24 and the abutting parts 68, 68 of the base wall 66 of the needle holding member 46 are butted against each other in an approximately vertical direction. Thus, the needle holding member 46 is prevented from moving upward with respect to the housing member 24, thereby stably puncturing the thin-walled part 150 of the lid member 146 with the lower projection 50 of the transfusion needle 22.

Then, the vial 14 is inserted into the drug preparation device 16 (the coupler 10) to the depth, namely, until the ring-shaped member 148 or the lid member 146, which is the upper end of the vial 14, abuts against the bottom wall part 52 of the needle holding member 46. By so doing, as shown in FIG. 12, the ring-shaped member 148 located on the radially outer side of the vial 14 pushes the protrusion distal end portions of the elastic contact pieces 70 of the needle holding member 46 and the second elastic pieces 36 of the housing member 24 radially outward (to the opposite sides in the left-right direction in FIG. 12), thereby releasing the abutment between the second elastic pieces 36 and the abutting parts 68, 68. As a result, the needle holding member 46 can move upwardly with respect to the housing member 24.

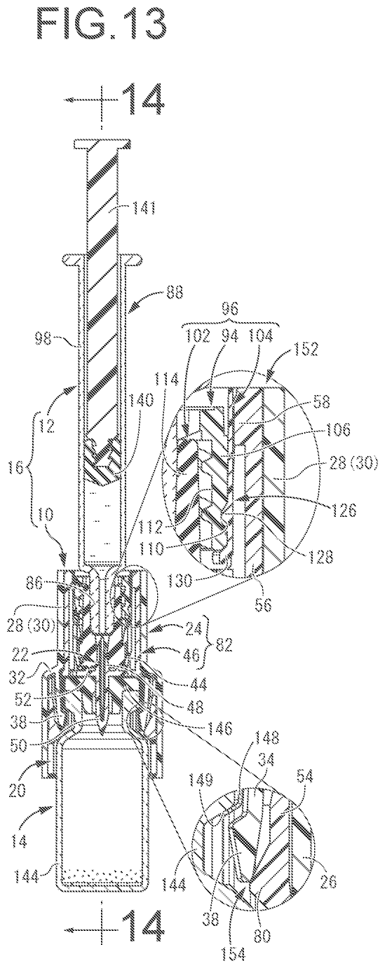

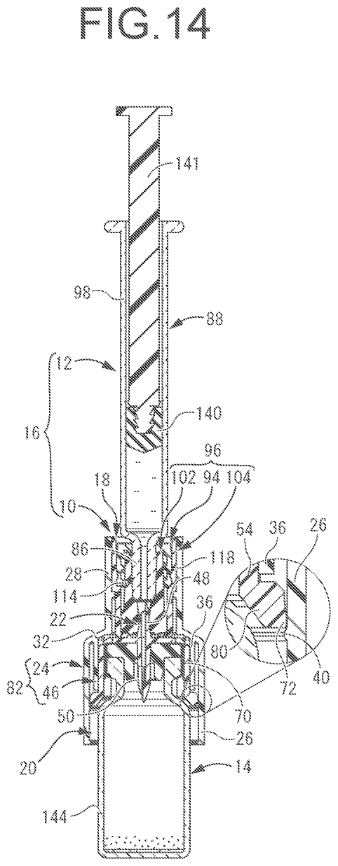

In the state where the needle holding member 46 can move upwardly with respect to the housing member 24, by further pushing and inserting the vial 14 into the drug preparation device 16 (the coupler 10), pushing force by insertion of the vial 14 is exerted on the needle holding member 46 having the transfusion needle 22. Thus, as shown in FIGS. 13 and 14, the vial 14 and the needle holding member 46 are moved upward with respect to the housing member 24. As a result, the transfusion needle 22 moves in a direction of getting closer to the syringe 12, and the upper projection 48 of the transfusion needle 22 punctures and penetrates the obstruction part 116 of the cap 102 that covers the nozzle part 86 of the syringe 12. By so doing, the internal space of the syringe 12 and the internal space of the vial 14 are placed in communication with each other by the transfusion needle 22. Specifically, in this practical embodiment, the coupler 10 coupling the syringe 12, which is fixedly equipped with the lock collar 94, and the vial 14 comprises the transfusion needle unit 82 (the housing member 24 and the needle holding member 46) and the cap 102 as well as the cap holder 104 of the cap unit 96. When the upper projection 48 punctures the obstruction part 116, the tapered part 51 provided to the lower part of the upper projection 48 abuts against the inner circumferential surface of the lower end of the cap 102, so that the space between the transfusion needle 22 and the cap 102 is airtightly sealed.

Then, in the communicating state between the syringe 12 and the vial 14, by pushing in the plunger 141 to the distal end side (the lower side), the solution or the like in the syringe 12 is injected into the vial 14. By so doing, the powder preparation or the like in the vial 14 is mixed with the solution or the like and dissolved, thereby preparing the drug. After the drug preparation, the drug preparation device 16 is turned upside down and the plunger 141 is pulled toward the user's hand (downward), so that the drug in the vial 14 is contained in the syringe 12.

Here, when the vial 14 is inserted into the transfusion needle unit 82 to place the syringe 12 and the vial 14 in communication as shown in FIG. 13, the deformation limiting parts 58 of the needle holding member 46 are positioned above and away from the radially outer side of the engaged portion between the cap holder 104 and the lock collar 94, namely, the engaged portion between the engaging convex parts 128, 128 and the concave groove 110. This allows the elastic engaging parts 126, 126 to deform radially outward, and the engaging convex parts 128, 128 are disengaged from the concave groove 110 due to the radially outward deformation of the elastic engaging parts 126, 126.

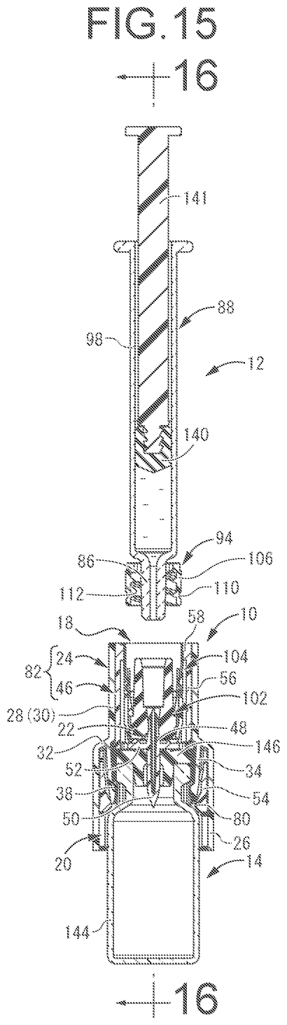

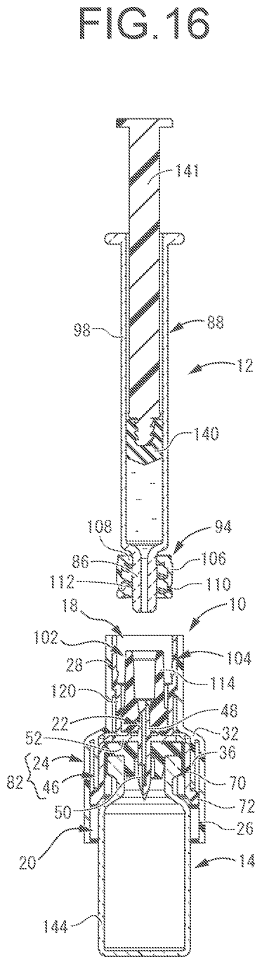

The lock collar 94 is fixedly attached to the syringe main body 88. Thus, by pulling out the syringe main body 88 from the transfusion needle unit 82, the elastic engaging parts 126, 126 elastically deform to the radially outer side to disengage the engaging convex parts 128, 128 and the concave groove 110. Accordingly, as shown in FIGS. 15 and 16, the lock collar 94 is pulled out from the transfusion needle unit 82 together with the syringe main body 88. In particular, since the lower inner surface of the concave groove 110 and the lower surfaces of the engaging convex parts 128, 128 all slope radially outward toward the bottom, the elastic engaging parts 126, 126 easily deform to the radially outer side along these slopes.

Specifically, the coupler 10 (the drug preparation device 16) of this practical embodiment is provided with a release mechanism 152 (see FIG. 13) that releases holding of the engaged state between the elastic engaging parts 126, 126 (the engaging convex parts 128, 128) and the concave groove 110 of the lock collar 94 in the aforementioned holding mechanism 143 due to the syringe 12 and the vial 14 being moved relatively closer to each other to be placed in communication by the transfusion needle 22. In particular, in this practical embodiment, due to the transfusion needle 22 (the needle holding member 46) being moved in the direction of getting closer to the syringe 12 to puncture the cap 102, the deformation limiting parts 58, 58 move to a position away from the elastic engaging parts 126, 126 of the cap holder 104 attached to the syringe 12 such that detachment of the elastic engaging parts 126, 126 from the concave groove 110 of the lock collar 94 is allowed by the radially outward deformation of the elastic engaging parts 126, 126 to constitute the release mechanism 152.

Here, the engaging convex parts 128, 128 and the concave groove 110 are engaged also in the left-right direction in FIG. 14. However, as mentioned above, such engaging convex parts 128, 128 have a smaller protruding volume than the engaging convex parts 128, 128 formed on the inner circumferential surface of the elastic engaging parts 126, 126, and the engaging force on the concave groove 110 is smaller. Therefore, the engagement with the concave groove 110 can be forcibly released by pulling-out operation of the syringe main body 88 from the transfusion needle unit 82. Indeed, the engaging convex parts 128 formed on the opposite sides in the left-right direction in FIG. 14 (on the peripheral wall inner surface of the large-diameter part 118) are provided as necessary to adjust the engaging force on the concave groove 110 of the lock collar 94 or the like, and are not necessarily provided.

As shown in FIG. 13, when the vial 14 is inserted into the transfusion needle unit 82 to place the syringe 12 and the vial 14 in communication, the locking claws 38 of the first elastic pieces 34 of the housing member 24 enter the constricted part 149 of the vial main body 144 and are locked in place. Meanwhile, the inward projections 80 of the needle holding member 46 are in abutment against the first elastic pieces 34 from the radially outer side. By so doing, even when external force is applied to the vial 14 in the direction of dislodgment (downward), the first elastic pieces 34 are prevented from deforming radially outward and the first elastic pieces 34 (the locking claws 38) remain locked to the vial main body 144.

In particular, due to the needle holding member 46 moving upward with respect to the housing member 24, the outer circumferential protrusions 72 of the needle holding member 46 climb over the circumferential rib 40 located above the lower end (the lower opening 25b) of the housing member 24 and are locked in place. This prevents the needle holding member 46 from moving downward (moving in the direction of separation from the housing member 24), and the abutment of the inward projections 80 against the first elastic pieces 34 from the radially outer side is stably maintained. As a result, the vial 14 is prevented from becoming dislodged from the drug preparation device 16 (the transfusion needle unit 82).

Specifically, in the housing member 24 of this practical embodiment, on the opening side (the lower opening 25b side) where the vial 14 can be attached, there is provided a second locking mechanism 154 that permits insertion of the vial 14 while preventing its detachment. That is, as shown in FIG. 12, the second elastic pieces 36 of the housing member 24 deform radially outward to permit insertion of the vial 14. Besides, as shown in FIG. 13, the first elastic pieces 34 are locked in the constricted part 149 of the vial 14 to prevent detachment of the vial 14. By so doing, the second locking mechanism 154 comprises the first elastic pieces 34 and the second elastic pieces 36.

The syringe 12 detached from the transfusion needle unit 82 as shown in FIGS. 15 and 16 includes the lock collar 94 having the female thread 112 on the radial inside. Thus, the syringe 12 can be connected to a luer-lock connector or the like (not shown), which includes a male thread that screws with the female thread 112. Through the said luer-lock connector or the like, the drug contained in the syringe 12 can be administered into the patient's body.

According to the coupler 10 of this practical embodiment as described above, the holding mechanism 143 is provided to hold the engaging parts of the cap holder 104 (the elastic engaging parts 126, 126) in an engaged state with the lock collar 94. This holding mechanism 143 comprises the deformation limiting parts 58, 58, which limit the radially outward elastic deformation of the elastic engaging parts 126, 126, thereby holding the convexo-concave engagement between the elastic engaging parts 126, 126 (the engaging convex parts 128, 128) and the concave groove 110 of the lock collar 94.

Besides, the coupler 10 is provided with the release mechanism 152 to release the holding of the convexo-concave engagement obtained by the holding mechanism 143 between the elastic engaging parts 126, 126 and the concave groove 110 of the lock collar 94. In this release mechanism 152, due to insertion of the vial 14 into the coupler 10, the deformation limiting parts 58, 58 move to a position away from the elastic engaging parts 126, 126 so as to allow the radially outward elastic deformation of the elastic engaging parts 126, 126, thereby releasing the convexo-concave engagement between the elastic engaging parts 126, 126 (the engaging convex parts 128, 128) and the concave groove 110 of the lock collar 94.

That is, coupling and detachment of the syringe 12 and the coupler 10 are achieved by these holding mechanism 143 and release mechanism 152. Thus, the structure of the coupler 10 and the syringe 12 can be made simple without a special thread structure as in the aforementioned Patent Document 1, for example. This makes it possible to improve the degree of freedom in designing the shapes of the coupler 10 and the syringe 12, to improve the degree of freedom in selecting the material thereof, and the like.

Besides, the housing member 24 is provided with the first locking mechanism 142 that permits insertion and prevents detachment of the cap 102 and the cap holder 104, and the second locking mechanism 154 that permits insertion and prevents detachment of the vial 14. This can prevent the cap 102 and the cap holder 104 as well as the vial 14 from accidentally falling out of the coupler 10 (the housing member 24). Also, when the nest syringe 97 is attached to the coupler 10 to form the drug preparation device 16, the cap 102 and the cap holder 104 are fixed to the housing member 24 and their detachment is prevented. Thus, by pulling out the syringe main body 88, the syringe 12 can be removed with the lock collar 94 included. In other words, by pulling out the syringe 12 from the coupler 10, the cap 102 and the cap holder 104, whose detachment is prevented by the first locking mechanism 142, are remain in the housing member 24.

Specifically, in this practical embodiment, when the syringe 12 is detached from the syringe attachment part 18, the cap 102, which is separated from the nozzle part 86 of the syringe 12, is retained in the syringe attachment part 18 by the first locking mechanism 142 via the cap holder 104. Thus, in this practical embodiment, the first locking mechanism 142 constitutes a cap retaining mechanism that holds the cap 102 mounted onto the nozzle part 86 at the time of attachment of the syringe 12 to the syringe attachment part 18 while holding the cap 102, which is separated from the nozzle part 86, on the syringe attachment part 18 at the time of detachment of the syringe 12 from the syringe attachment part 18. The cap retaining mechanism (the first locking mechanism 142) realizes the aforementioned holding and retaining of the cap 102 via the cap holder 104. This eliminates the need to remove the cap 102 from the syringe 12 when connecting the pulled-out syringe 12 to a luer-lock connector or the like. In addition, the user may be prevented from accidentally touching the cap 102, to which the drug or the like adheres, after the syringe 12 has been pulled out.

The drug preparation device 16 comprising the syringe 12 combined with such coupler 10 can also achieve the above effects. In particular, since the syringe main body 88 and the lock collar 94 are separate components in the drug preparation device 16 of this practical embodiment, the syringe main body 88 can be more easily shaped, and for example, the syringe main body 88 can be made of glass. Alternatively, a commercially-available syringe main body made of glass can be adopted as the syringe main body 88 to be employed by the drug preparation device 16.

A practical embodiment of the present invention has been described in detail above, but the present invention is not limited to those specific descriptions.

In the preceding practical embodiment, the holding mechanism 143 comprises the deformation limiting parts 58, 58 that limit the radially outward elastic deformation of the engaging parts (the elastic engaging parts 126, 126), but the holding mechanism 143 is not limited to such an embodiment. For example, it would also be acceptable that the outer circumferential surface of the lock collar is provided with an axial groove opening downward while extending in the axial direction and a circumferential groove extending in the circumferential direction from the upper end of the said axial groove. By inserting an engaging part provided on the cap holder from the lower opening of the axial groove, and with the engaging part located at the upper end of the axial groove, by rotating the lock collar with respect to the cap holder to insert the engaging part into the circumferential groove, the engaging part of the cap holder and the lock collar may be mutually engaged. Then, for example, in the initial state, a movement restricting part may be provided on the arm part of the needle holding member, and restricts circumferential movement and axial movement of the engaging part within the groove to maintain the engaged state, while the movement of the needle holding member due to the insertion of the vial may release the restriction of the movement of the engaging part in the groove to release the engaged state between the engaging part of the cap holder and the lock collar. That is, the release of engagement between the engaging part of the cap holder and the lock collar is not limited to the embodiment performed by the radially outward elastic deformation of engaging part, but may be achieved by the vertical movement or the circumferential movement of the engaging part. In that case as well, for example, the holding mechanism for holding the engaged state is constituted by including the movement restricting part provided at the protruding distal end of the arm part of the needle holding member, while the release mechanism for releasing the holding of the engaged state obtained by the holding mechanism due to the movement of the movement restricting part is constituted. When the cap holder and the lock collar are rotated relative to each other, it is suitable to rotate the syringe and the cap holder relative to each other with the lock collar fixed to the syringe, and in this case, it is preferable that the lock collar is nonrotatably fixed to the syringe main body.

Moreover, the concave part in the lock collar 94 (the concave groove 110) and the convex part of the elastic engaging part 126 (the engaging convex part 128) may be conversely provided, namely, the lock collar may be provided with a convex part and the elastic engaging part may be provided with a concave part. These concave part and/or convex part need not be provided over the entire circumferential circumference, but it may be acceptable as long as the concave part and the convex part are provided at least at positions corresponding to each other in the circumferential direction.

Furthermore, in the preceding practical embodiment, the syringe main body 88 is made of glass, but the syringe main body may be made of synthetic resin. Besides, in the preceding practical embodiment, the syringe main body 88 and the lock collar 94 are separate components, but for example, the syringe main body and the lock collar may be formed as an integrally molded component made of synthetic resin.

Additionally, in the preceding practical embodiment, the needle holding member 46 and the double-ended needle (the transfusion needle 22) are formed as an integrally molded component made of synthetic resin. However, the needle holding member 46 and the double-ended needle may be formed separately and then adhered together, or may be formed by insert molding, multicolor molding, or the like. In this case, the double-ended needle may be formed of metal, for example.

In the preceding practical embodiment, the engaging convex part 128 of the elastic engaging part 126 comes into convexo-concave engagement with the outer circumferential surface of the lock collar 94 (the concave groove 110), and the deformation limiting part 58 abuts against the said convexo-concave engaged portion from the radially outer side, thereby preventing the lock collar 94 from becoming dislodged from the cap holder 104. However, for example, the location of the engaged portion is not limited to the outer circumferential surface of the lock collar as long as the deformation limiting part limits the radially outward deformation of the engaging part so as not to release the engagement. For example, engaged portion may be located at the upper end of the peripheral wall of the lock collar, and in this case, the engaging part may be a claw-shaped or hook-shaped part that engages with the upper end of the peripheral wall of the lock collar.

Also, the drug preparation device according to the present invention is acceptable as long as it has a structure in which a coupler is combined with a syringe main body including a lock collar. For example, an embodiment as shown in FIG. 9 mentioned above may be adopted as the drug preparation device according to the present invention. In the drug preparation device of such an embodiment, any liquid can be injected into the syringe main body, and then the device can be used, provided, or the like by attaching a separately prepared gasket or gasket with plunger. In addition, upon provision, the coupler and the syringe main body including the lock collar may be provided in a separate state.

### KEYS TO SYMBOLS

10 coupler
12 syringe
14 vial
16 drug preparation device
18 syringe attachment part
20 vial attachment part
22 transfusion needle (double-ended needle)
24 housing member
25a upper opening
25b lower opening
26 large-diameter tube part
28 small-diameter tube part
30 bulging part
32 annular wall part
34 first elastic piece
36 second elastic piece
38 locking claw
40 circumferential rib
42 axial rib
43 inside wall part
44 elastic locking piece
45a protrusion proximal end portion
45b protrusion distal end portion
46 needle holding member
48 upper projection
50 lower projection
51 tapered part
52 bottom wall part
54 peripheral wall part
56 arm part
58 deformation limiting part
60 insertion hole
62 fitting protrusion
64 accommodation region
66 base wall
68 abutting part
70 elastic contact piece
72 outer circumferential protrusion
74 axial groove
76 axial rib
78 lower opening
80 inward projection
82 transfusion needle unit
86 nozzle part
88 syringe main body
94 lock collar
96 cap unit
97 nest syringe
98 barrel part
100 annular recess
102 cap
104 cap holder
106 peripheral wall
108 locking part
110 concave groove
112 female thread
114 peripheral wall
116 obstruction part
117 thick-walled part
118 large-diameter part
120 small-diameter part
122 stepped part
124 slit
126 elastic engaging part (engaging part)
128 engaging convex part
130 engaging claw part
132 through window
134 bottom plate
136 lower opening
138 upper opening
140 gasket
141 plunger
142 first locking mechanism (cap retaining mechanism)
143 holding mechanism
144 vial main body
146 lid member
148 ring-shaped member
149 constricted part
150 thin-walled part
152 release mechanism
154 second locking mechanism

1. A coupler comprising:
a syringe attachment part configured to detachably receive a syringe including a nozzle part, the nozzle part having a lock collar;
a vial attachment part configured to receive a vial;
a double-ended needle configured to place the syringe and the vial in communication;
a cap holder including an engaging part configured to engage with the lock collar;
a cap configured to cover the nozzle part of the syringe, the cap being attached to the cap holder;
a holding mechanism configured to hold the engaging part in an engaged state with the lock collar; and
a release mechanism configured to release holding of the engaged state between the engaging part and the lock collar in the holding mechanism due to the syringe and the vial being moved relatively closer to each other to be placed in communication by the double-ended needle.

2. The coupler according to claim 1, further comprising a cap retaining mechanism configured to hold the cap attached to the nozzle part of the syringe in the syringe attachment part, the cap retaining mechanism being configured to retain the cap separated from the nozzle part when the syringe is detached from the syringe attachment part.

3. The coupler according to claim 1, wherein
the engaging part of the cap holder is configured to come into convexo-concave engagement with an outer circumferential surface of the lock collar, and
the holding mechanism comprises a deformation limiting part that is arranged on a radially outer side of the engaging part and is configured to limit radially outward deformation of the engaging part thereby holding the engaging part in the engaged state with the outer circumferential surface of the lock collar.

4. The coupler according to claim 3, wherein
the deformation limiting part is integrally provided with the double-ended needle, and
due to the double-ended needle being moved in a direction of getting closer to the syringe to puncture the cap, the deformation limiting part is configured to move to a position away from the engaging part of the cap holder attached to the syringe such that detachment of the engaging part from the lock collar is allowed by the radially outward deformation of the engaging part to constitute the release mechanism.

5. The coupler according to claim 4, wherein the double-ended needle is configured to be subjected to pushing force by insertion of the vial, and the pushing force causes the double-ended needle to move in the direction of getting closer to the syringe to puncture the cap.

6. The coupler according to claim 1, further comprising a housing member having a tubular shape and configured to receive the syringe and the vial respectively on a first axial opening side and a second axial opening side, wherein
the double-ended needle is attached to the housing member movably in an axial direction,
a first locking mechanism is provided on the first axial opening side of the housing member, the first locking mechanism permitting insertion of the cap and the cap holder while preventing detachment of the cap and the cap holder, and
a second locking mechanism is provided on the second axial opening side of the housing member, the second locking mechanism permitting insertion of the vial while preventing detachment of the vial.

7. A drug preparation device comprising:
the coupler according to claim 1; and
the syringe combined with the coupler, the syringe being detachable with respect to the syringe attachment part and comprising:
a syringe main body; and
the lock collar that is a separate component from the syringe main body and is fixedly attached to the nozzle part of the syringe main body.
